(19) United States
(12) Patent Application Publication
(10) Pub. No.: US 2007/0152800 A1
(43) Pub. Date: Jul. 5, 2007

(54) Voice interface for finding and selecting an option, in particular for a mobile telephone on board a vehicle

(76) Inventor: Henri Seydoux, Puteaux (FR)

Correspondence Address: NIXON & VANDERHYE, PC, 901 NORTH GLEBE ROAD, 11TH FLOOR, ARLINGTON, VA, 22203, US

(21) Appl. No.: 10/585,866

(22) PCT Filed: Jan. 4, 2005
(86) PCT No.: PCT/FR05/00006

§ 371 Date: Dec. 7, 2006

(30) Foreign Application Priority Data
Jan. 28, 2004 (FR) 0400806

(51) Int. Cl. B60R 25/10

(52) U.S. Cl. 340/426.16; 345/184; 340/426.2

(57) ABSTRACT

The device (10) comprises, in association with a mobile telephone (30) on board a vehicle, a memory (22) containing a plurality of options ordered in a sequential list, selector means (24) comprising a two-directional rotary knob (14) that can be manipulated (26) by the user in order to increment or decrement a pointer for selecting options, and processor means suitable for executing predetermined actions as a function of the options in the memory. The device is also provided with acoustic means (20) suitable for generating an audible message constituting a voiced representation of the option selected as a response to the pointer being incremented or decremented. Confirmation means (24) such as a transient contact actuated by pressing (28) on the rotary knob serve to trigger execution of the corresponding action.

The invention relates to a device for assisting in dialing telephone numbers, and more generally to assisting in navigation in the hierarchy of menus for controlling appliances such as portable telephones.

Telephone numbers are usually dialed from a keypad and a display, or by using a selector device (such as arrow keys or a scroll wheel) which, on being manipulated, enable a user to make a selection in a list which is presented on the display (a list of names, of telephone numbers, or of menu items).

Nevertheless, there are occasions when it is not desirable, or even not possible, to use the display, particularly with telephones on board motor vehicles, and regardless of whether the telephone is integrated in the vehicle or is a mobile telephone being used inside the vehicle in combination with a “car kit” i.e. a car adapter for a mobile radio telephone that serves in particular to provide it with a “handsfree” mode of operation.

Under such circumstances, when the user is the driver, it is necessary to avoid distracting the driver's attention and sight by making the driver look at the display.

In addition, since the display is generally small in size, it is difficult to read, unless the user is close to the telephone (for a cordless device) or unless the user moves closer to the display (when integrated in the dashboard); however under any circumstances those are actions that are dangerous and to be avoided.

One solution consists in providing a voice recognition system as described for example in WO-A-98/45997 (Parrot): when the radio telephone is placed on a cradle, an adapter integrated in the vehicle takes over managing telephone functions and they can then be operated by voice commands and/or a transient press (a single or a double click) on a single control button. Functions such as taking the telephone off-hook, looking for a third party's number, dialing that number, etc., can thus be managed in simple and effective manner.

Other voice-controlled telephone systems are described in U.S. Pat. No. 6,029,072, US-A-2003/114202, and US-A-2002/197954.

Because they make use of voice recognition, those devices nevertheless require prior training, if only to record the voice print associated with each third party name or with each command. Those devices thus require all of the names or commands to be recorded beforehand, with this being necessary for each person likely to use the appliance. There are as many voice prints as there are different speakers, and the use of such appliances is therefore restricted to a small number of individuals.

One of the objects of the invention is to propose a telephone selector device in which, as in the above device, the user does not need to look at a display, but which can be implemented without having recourse to a voice recognition system and/or under special circumstances such as: use by a person other than the person who undertook the training; or use by the person who did undertake the training in order to dial safely a number for which the corresponding voice print has been forgotten; or indeed using voice prints in situations when it is not possible to use the voice recognition system—for example in the presence of high levels of vocal noise coming from young passengers in the back of the vehicle.

In a manner that is itself known, the device of the invention comprises: a data memory containing a plurality of said options ordered as a sequential list; a pointer for selecting one of the options of the list; selector means suitable for incrementing or decrementing the pointer in response to controlled manipulation by the user; and processor means suitable for executing a set of predetermined actions as a function of the options in the data memory.

In a manner characteristic of the invention, the device further comprises: acoustic means suitable for sending to the user an audible message constituting a voiced representation of the option selected by the pointer in response to said pointer being incremented or decremented; and confirmation means that can be manipulated by the user, suitable for reading the option selected by the pointer and transferring said option to the processor means for executing the corresponding action. The selector means comprise a two-directional rotary knob that can be manipulated by the user, and the confirmation means comprising a transient contact that can be actuated by pressing on the rotary knob.

The device may further comprise means for displaying the option selected by the pointer, which means preferably also display at least one of the next and/or previous options in the list.

These options may contain:
names with a telephone number associated with each option; the action executed by the processor means is then dialing the corresponding telephone number;
letters of the alphabet; the action executed by the processor means is then positioning the pointer on the first name beginning with the selected letter; and/or
the titles of control menus or the titles of lower-level menus; the action executed by the processor means is then executing the corresponding command, or selecting the corresponding menu of a lower level.

There follows a description of an embodiment of the device of the invention, given with reference to the accompanying drawings.

FIG. 1 is a general external view of the device of the invention.

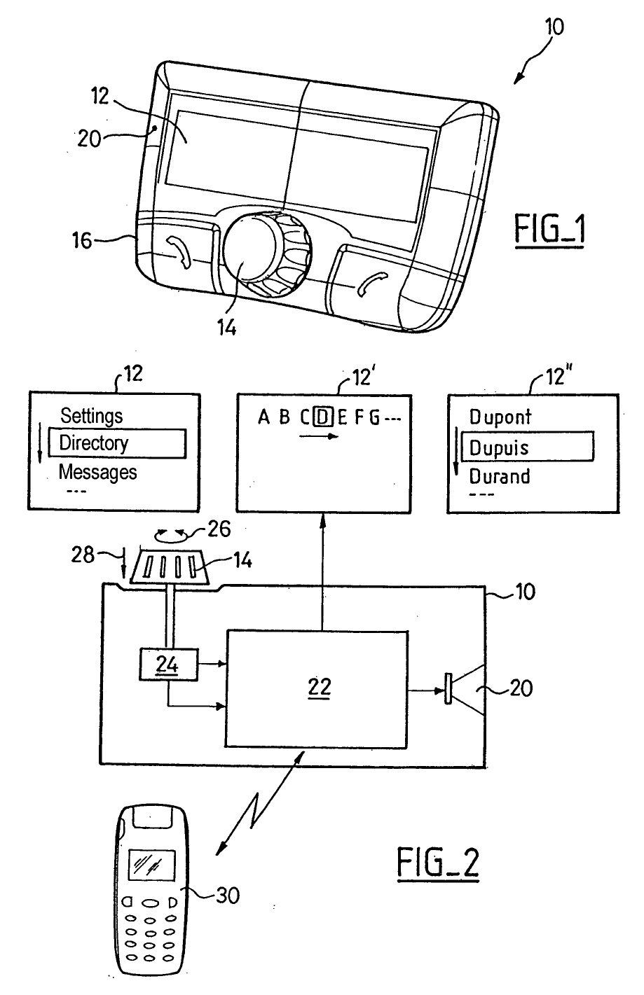

FIG. 2 is a block diagram of the device together with the telephone with which it is interfaced, showing examples of the kinds of display that might be reproduced on the screen.

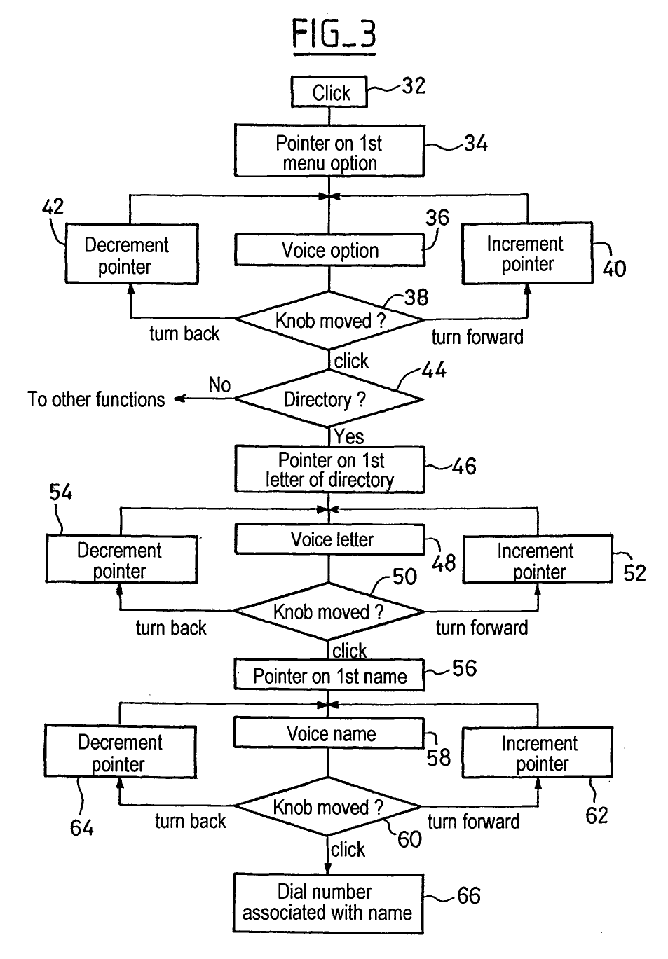

FIG. 3 is a flow chart showing how the device is used.

As mentioned above, the preferred application of the invention is that of radio telephones used on board vehicles, in particular “car kits”, i.e. car adapters serving in particular to provide the radio telephone with “handsfree” operation. Nevertheless, this application is not limiting, and the invention can be usefully applied to numerous other equipments or circuits installed in a vehicle or incorporated permanently therein such as a car radio, an on-board computer, equipment providing assistance in navigation, etc.

In the example shown, the device of the invention takes the form depicted in FIG. 1.

A housing 10, optionally integrated in the vehicle dashboard, is provided with a display 12, a knurled knob 14, and two keys 16 and 18 similar to the green and red keys usually to be found on a portable telephone (green=take off hook/dial; red=hang up/cancel). The housing 10 also includes a transducer 20 such as a loudspeaker or the like for playing back audible messages to the user.

As shown in the block diagram of FIG. 2, the device 10 incorporates a circuit 22 receiving as input via a contactor 24 information about the knob 14 being moved. The knob can be manipulated both by being caused to turn about its axis in one direction or the other (arrows 26), and also by being subjected to transient axial pressure so as to perform a “click” (arrow 28).

The device 10 is a mobile telephone interface 30. The connection between the device 10 and the telephone 30 can be implemented in a variety of known ways. It may be constituted by a cradle system that receives the telephone and that is connected to a universal unit integrated in the vehicle, as described in EP-A-1 363 443 (Parrot). In a variant, and advantageously, the telephone 30 is connected to the circuit 22 of the device 10 via a wireless connection such as a connection of the Bluetooth® type. The Bluetooth® specifications make provision for the option of remotely controlling all of the functions of a mobile telephone over a both-way wireless link, where such functions are: taking off hook, hanging up, dialing, navigating through menus, navigating directories, etc., with control of the mobile telephone being taken over in full and remotely, and taking over completely from its keypad.

The commands available to the user are thus restricted to the knob 14 (turning and pressing) and to the two keys 16 and 18. It should be observed that the display 12 described in this example has a subsidiary function only and does not intervene in implementing the invention, which essentially makes use solely of acoustic means in combination with the controls 14, 16, and 18. The display 12 serves only as a visual reminder of acoustic messages, such that if the user desires to use the appliance without taking account of the acoustic messages, e.g. in order to navigate more quickly when it is not dangerous for the user to take the eye off the road and look at the screen.

There follows a description of how the device is used, given with reference to the flow chart of FIG. 3.

The use of the keys 16 and 18 is not described since they are the same as the green and red keys on a conventional mobile telephone, and they serve to control taking off hook and hanging up and are not in themselves necessary for implementing the invention.

In order to activate the device, the user clicks the knob 14 (step 32), i.e. presses transiently thereon, thereby having the effect of controlling a pointer which selects a first item from a menu (step 34) e.g. a menu for selecting one telephone function from a plurality, such as “dial”/“directory”/“settings”/“messages”, etc.

The corresponding menu item, e.g. “directory”, is then voiced by a voice synthesis device in the form of an acoustic message that is played back via the transducer 20 (step 36). The acoustic message may either be a prerecorded message, recorded in the device while it was being configured, or else a message synthesized by means of software for voice synthesis from the text of the menu item—i.e. the word “directory” is considered as being a string of alphabetic characters that is to be read out loud, being subdivided into a sequence of syllables and then synthesized by appropriate voice synthesis software. The acoustic message may also be a voice print recorded by the voice recognition system.

The device then waits for an action on the knob 14 (step 38).

If the knob is turned in one direction or the other, then the pointer is incremented or decremented (steps 40, 42) so as to select the preceding item or the following item in the same menu, as appropriate. The item newly pointed to is then voiced in turn (step 36), until a new movement of the knob 14 is detected (step 38), and so on.

As shown at 12, to the left of FIG. 2, the display shows a list of various items, or at least part of such a list, highlighting the particular item that is currently designated by the pointer, for example by marking a box around the item.

If the user selects the “directory” item from the menu by pressing on the knob 14 (step 44), the device will then be in a position to select a name from the directory, initially sorted alphabetically on the first letters of the names, and subsequently from amongst all names beginning with a given letter.

The device begins by pointing to the first letter of the alphabet, or at least the first letter for which there exists the name in the directory (step 46). This letter is voiced (step 48) so that it can be heard by the user.

The user then turns the knob 14 in one direction or the other in order to go to the next letter or the preceding letter (steps 52, 54) in the alphabet, and that letter will in turn be voiced after being selected (step 48), and so on. The user can thus scan very quickly through the alphabet by turning the knob 14 until reaching the first letter of the name that is to be selected, e.g. “D”.

During this stage of selecting the letter, and as shown at 12′ in the middle of FIG. 2, the display shows all or part of the alphabet with the selected letter being highlighted by being framed.

Once the user has found the desired letter, pressing the knob 14 has the effect of causing the pointer to select the first name in the list of the names that begin with this letter (step 56). This name is then voiced (step 58) so that it can be heard. The user can then turn the knob 14 in one direction or the other in order to go to the next name or the preceding name in the list (steps 62, 64), and the new name will be voiced after being selected (step 58) and so on. The user can thus scan very quickly through the list by turning the knob 14 until hearing the name that is to be selected.

During this stage of selecting a name, as shown as 12″ on the right of FIG. 2, the display shows all part or part of the list with the selected-name being highlighted by a frame.

Once the name has been selected, the number associated with that name is dialed by a final press on the knob 14 (step 66) or by pressing on the dial/answer, green button 18.

As will be understood, numerous variant implementations can be envisaged.

Thus, when the list of names is short, it may be simpler to omit the alphabetic selection step (steps 46 to 54), so that turning the knob 14 scans directly through the list of names once the “directory” function has been selected.

Similarly, during a call, turning the knob 14 can perform some other function, for example varying sound volume level during a conversation.

1. A device (10) forming an interface for finding and selecting an option in a hierarchical directory, in particular for searching for and selecting a number in a directory of a mobile telephone (30) on board a vehicle, the device comprising:
a data memory (22) containing a plurality of said options ordered as a sequential list;
a pointer for selecting one of the options of the list;
selector means (24) suitable for incrementing or decrementing the pointer in response to controlled manipulation by the user; and
processor means suitable for executing a set of predetermined actions as a function of the options in the data memory;
the device being characterized in that it further comprises:
acoustic means (20) suitable for sending to the user an audible message constituting a voiced representation of the option selected by the pointer in response to said pointer being incremented or decremented; and
confirmation means (24) that can be manipulated by the user, suitable for reading the option selected by the pointer and transferring said option to the processor means for executing the corresponding action;
and in that said selector means comprise a two-directional rotary knob (14) that can be manipulated (26) by the user, said confirmation means comprising a transient contact that can be actuated by pressing (28) on said rotary knob.

2. The device of claim 1, further comprising display means (12) for displaying the option selected by the pointer.

3. The device of claim 2, in which the display means (12) also display at least one of the preceding and/or following options in the list.

4. The device of claim 1, in which:
said options contain names;
a telephone number is associated with each option; and
the action executed by the processor means is dialing the corresponding telephone number.

5. The device of claim 4, in which:
said options contain letters of the alphabet; and
the action executed by the processor means is positioning the pointer on the first name beginning by the selected letter.

6. The device of claim 1, in which:
said options contain command menu titles, or the titles of lower-level menus; and
the action executed by the processor means is to execute the corresponding command or to select the corresponding lower-level menu.
